(19) United States
(12) Patent Application Publication
(10) Pub. No.: US 2007/0185988 A1
(43) Pub. Date: Aug. 9, 2007

(54) Apparatus and method for directing content to a user by an internet service provider

(75) Inventor: Richard B. Maring, Hudsonville, MI (US)

Correspondence Address: THE WATSON INTELLECTUAL PROPERTY GROUP, PLC, 3133 HIGHLAND DRIVE, SUITE 200, HUDSONVILLE, MI, 49426, US

(73) Assignee: TRIBINIUM CORPORATION

(21) Appl. No.: 11/348,088

(22) Filed: Feb. 6, 2006

(51) Int. Cl. G06F 15/173

(52) U.S. Cl. 709/224

(57) ABSTRACT

A processor implemented method for directing content to a user by an internet service provider comprising the steps of: tracking the websites visited by a user; identifying at least one on-line business visited by the a user; and providing a link to the on-line business through a browser.

### BACKGROUND OF THE INVENTION

1. Field of the Invention

The invention relates in general to the direction of content to a user by an internet service provider (ISP). More particularly, the internet service provider can track the website visits of a user to develop a profile of the user's interests. This information can be passed to on-line businesses which can, in turn, provide the ISP with content to provide to the user toward selling goods or services to the user based upon the profile of the user's interest. It will be understood that in the present invention, and ISP may comprise a traditional ISP or an entity related to or accessible to the ISP which provides access to the Internet for at least one user. It will further be understood that on-line businesses may comprise any number of different organizations offering goods or services directly or indirectly to consumers over the Internet.

2. Background Art

On-line advertising has been a quickly developing business. Major forms of advertising comprise, for example, banner advertisements which are transmitted along with content to a user in response to the request for content. Generally, the banner ads are loosely or closely associated with the content. While associated with the content, the advertiser knows little to nothing about the user, and, as such, the banner ads are not associated with the user.

Inasmuch as the banner advertisements are typically unsolicited, the banner advertisers rely on making millions of impressions for relatively few “click-throughs” made by a user in response to a banner ad.

Other advertising relies upon the transmission of email to various users. Such email transmission may be unsolicited (spam) or may be permission based email. In the best case, the email is sent based upon a prior purchase or prior review of a good or service of a on-line business. As such, there is at least some association between the good or service and the user. However, typically, these advertisements can be annoyances to users as users are typically bogged down with dozens of email advertisements.

In an effort to provide more directed advertising to users surfing the Internet, search engines such as Google have begun to offer advertisers new manners in which to target advertisement to the proper individuals. In particular, on-line businesses can purchase, or bid, for terms, such that the highest bidder will have either a sponsored link or an advertisement placed on the first page of results. While such advertisement may be substantially more targeted than the foregoing, there remain drawbacks. In particular, the targeted advertising is based upon the currently requested. search. There is no other information regarding the user (such as, for example, the last 50 visited websites and the last 50 searches). Such information would be highly valuable to a business when targeting on-line advertising.

Thus, it is an object of the present invention to direct content to a user based upon information gathered by the ISP.

It is another object of the present invention to provide the user directed advertisement through the browser based upon information gathered by the ISP.

It is another object of the present invention to provide an incentive to business relative to affiliating with the ISP.

These objects as well as other objects of the present invention will become apparent in light of the present specification, claims, and drawings.

### SUMMARY OF THE INVENTION

The invention is directed, in one aspect to a processor implemented method for directing content to a user by an internet service provider comprising the steps of tracking the websites visited by a user; identifying at least one on-line business visited by the a user; and providing a link to the on-line business through a browser.

In a preferred embodiment, the processor implemented method further comprises the steps of providing information pertaining to tracking of a user to an on-line business; receiving information pertaining to content suited to the user form the on-line business based upon the information provided to the on-line business; and providing the information to the user from the on-line business within the link provided to the user.

In one such embodiment, the step of providing information comprises the steps of: discretely providing the information within the link, such that the information is revealed when a pointer is positioned over the link.

In another embodiment, the step of tracking further comprises the steps of becoming an affiliate of at least one on-line business; identifying a request from a user for content from the at least one business; providing an affiliate identification along with the request for content from the at least one business; and obtaining the content from the at least one business for the user.

In one such embodiment, the step of identifying further comprises the steps of identifying each on-line business visited by the user of which the internet service provider is an affiliate; and maintaining an ranking of each on-line business based upon visits. The step of providing further comprises the step of providing a link to a predetermined number of on-line businesses based upon the ranking of each on-line business.

In one such preferred embodiment, the predetermined number of on-line businesses comprises at least the four most frequently visited on-line businesses by the user.

In another preferred embodiment, the processor implemented method further comprises the steps of: providing information pertaining to tracking of a user to an on-line business; receiving information pertaining to content suited to the user form the on-line business based upon the information provided to the on-line business; and providing the information to the user from the on-line business within the link provided to the user.

In one such embodiment, the step of providing information comprises the step of discretely providing the information within the link, such that the information is revealed when a pointer is positioned over the link.

In one embodiment, the link is provided in the form of a tool bar button within a browser window-of a user.

In another aspect of the invention, the invention comprises an apparatus for directing content to a user by an internet service provider comprising means for tracking the websites visited by a user; means for identifying at least one on-line business visited by the a user; and means for providing a link to the on-line business through a browser.

In one preferred embodiment, the apparatus further comprises means for becoming an affiliate of at least one on-line business; means for identifying a request from a user for content from the at least one business; means for providing an affiliate identification along with the request for content from the at least one business; and means for obtaining the content from the at least one business for the user.

In one such embodiment, the identifying means further comprises means for identifying each on-line business visited by the user of which the internet service provider is an affiliate, and, means for maintaining an ranking of each on-line business based upon visits. The providing means further comprises means for providing a link to a predetermined number of on-line businesses based upon the ranking of each on-line business.

In one such embodiment, the predetermined number of on-line businesses comprises at least the four most frequently visited on-line businesses by the user.

In another embodiment, the apparatus further comprises means for providing information pertaining to tracking of a user to an on-line business; means for receiving information pertaining to content suited to the user form the on-line business based upon the information provided to the on-line business; and means for providing the information to the user from the on-line business within the link provided to the user.

In yet another embodiment, the providing means further comprises means for discretely providing the information within the link, such that the information is revealed when a pointer is positioned over the link.

The invention is further directed to an article of manufacture for managing the viewing of images by a user comprising a computer-readable medium configured with instructions for causing a processor-based system to perform the steps of the methods identified above.

### BRIEF DESCRIPTION OF THE DRAWINGS

The invention will now be described with reference to the drawings wherein:

FIG. 1 of the drawings comprises a schematic representation of a on-line computer network, showing, in particular, the Internet, an exemplary ISP, an exemplary LAN, an exemplary computer attached to the exemplary LAN, and an exemplary computer attached to the ISP;

FIG. 2 of the drawings comprises a sample database of information maintained by the ISP pertaining to the browsing habits of a user, and including visited websites as well as the frequency of such visits;

FIG. 3 of the drawings comprises a sample website window showing the toolbar of the present invention having links positioned therein which relate to the information maintained by the ISP pertaining to browsing habits of a user;

FIG. 4 of the drawings comprises a flowchart of an aspect of the present invention, showing, in particular, the providing of affiliate information to an on-line business by an ISP;

FIG. 5 of the drawings comprises a flowchart of an aspect of the present invention, showing, in particular, the exchange of the information maintained by the ISP pertaining to the browsing habits of the user, and the receipt of information from the on-line business pertaining to information targeted to particular users; and

FIG. 6 of the drawings comprises an enlarged view of the toolbar of FIG. 3, showing, in particular, a discrete directed advertisement provided to a particular user in response to the information pertaining to the browsing habits of the particular user.

### DETAILED DESCRIPTION OF THE DRAWINGS

While this invention is susceptible of embodiment in many different forms, there is shown in the drawings and described herein in detail a specific embodiment with the understanding that the present disclosure is to be considered as an exemplification of the principles of the invention and is not intended to limit the invention to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

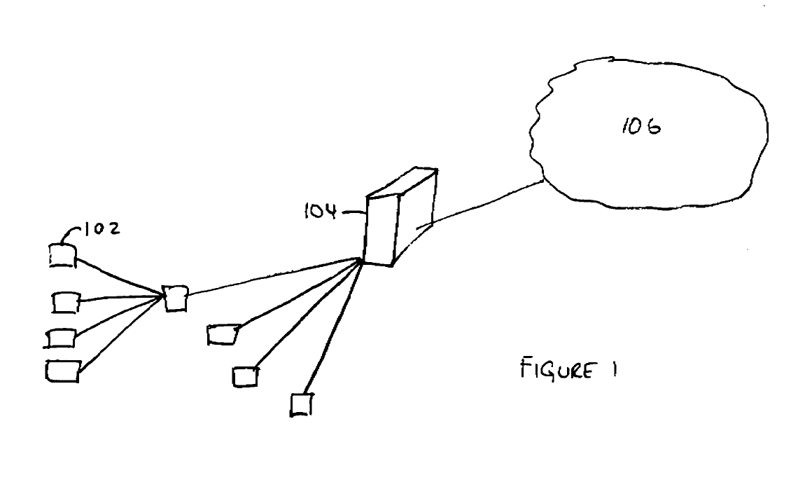

Referring now to the drawings and in particular to FIG. 1, the system is configured to operate in association with an on-line network of computers represented at 100. In a typical situation, a local computer 102 may be part of a local area network (LAN). The LAN is coupled to an Internet Service Provider (ISP) 104 for access to the Internet 106. As the user seeks content from the internet, the user identifies the particular website (through a URL or an IP address xxx.xxx.xxx.xxx). The query is sent to ISP 104 which seeks that address on Internet 106. When the content is located, the content is downloaded to ISP 104 and, subsequently, to local computer 102. With websites having heavy traffic from ISP 104, ISP 104 may maintain a copy of the content of the website such that every time a computer associated with ISP 104 requests the content, ISP 104 can provide the content from its own cache, rather than seeking the information from Internet 106 each time.

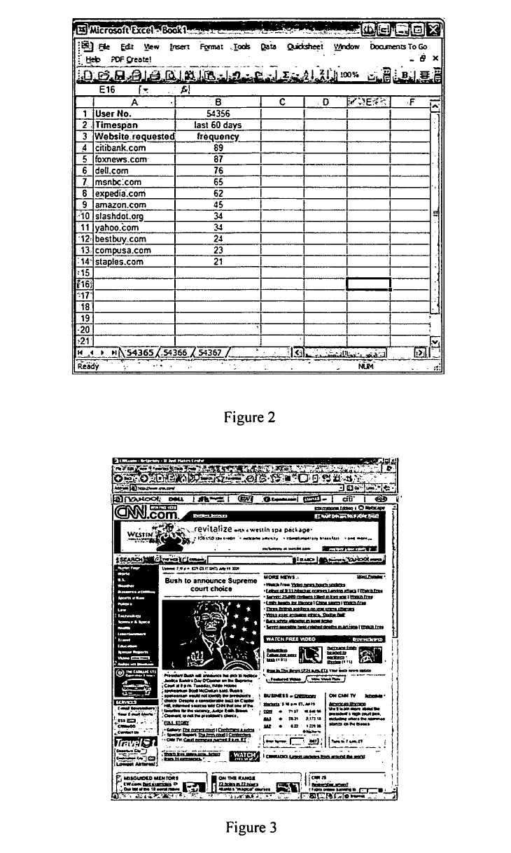

It is contemplated that the present apparatus is operated at the level of ISP 104, however, it may be implemented at other locations, such as between the ISP and the Internet, or between the ISP and the local computer. The apparatus may comprise software which is maintained and operated in a server or other computer coupled to ISP 104. The operation of the apparatus is explained with reference to FIGS. 2 through 5.

Each time a user requests content from the Internet, the ISP 104 can track the requested content. With respect to FIG. 2, the tracking information can be maintained in a database associated with the ISP. Over a predetermined time period, a substantial record can be formed for a particular user. This data includes a number of on-line businesses that are visited by the user. As is shown in FIG. 2, the particular user, number 54356, has made 89 visits to www.citibank.com, 76 visits to www.dell.com, each in the last 60 days. It may be desirable to track other information, such as time spent at the website, the particular pages visited at the website, among others.

Once the record is formed for a user, the system can be directed to provide links or buttons within the browser for the on-line businesses that are visited by the user. For example, and as is shown in Figure, a link toolbar may be provided by the ISP to appear in the browser window. The link toolbar can be populated by links corresponding to the on-line businesses visited by the user. The toolbar can be appended to the top of the page of content requested by the user. Of course, the toolbar or the link buttons can be placed elsewhere within the browser window. In other embodiments, software code can be downloaded by the user so as to place an additional toolbar amongst the other toolbars found in the browser. By clicking on the link provided in the toolbar, the user is directed to the website of the on-line business.

Generally, most on-line businesses provide an affiliate program. Affiliate programs generally provide an incentive to a website to include a link within a webpage for the on-line business. If a visitor to the particular webpage clicks on the link for the on-line business, and makes a purchase from the on-line business, the owner of the webpage having the link thereon earns a percentage of the total sale made by the user (or other commission or revenue). Thousands of on-line businesses participate or offer an affiliate program. Each user that clicks through the link on the webpage to the on-line business transmits an affiliate code to the on-line business along with the request for content from the on-line business. For example, the affiliate code may be appended to the website URL (i.e., www.amazon.com/retailemumber=xyz). On-line businesses can track the receipt of the code and the user's subsequent purchases made from the on-line business.

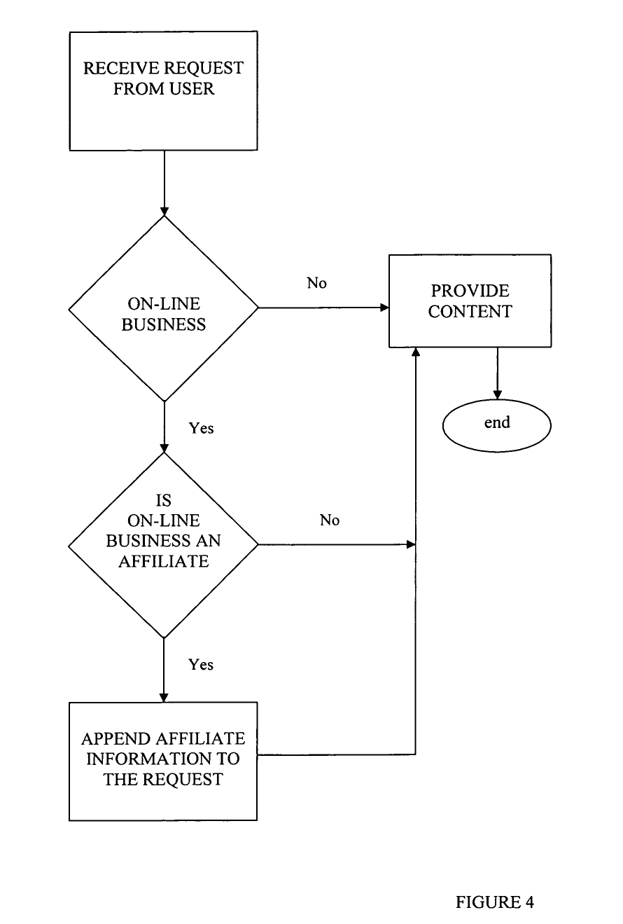

In the contemplated embodiment of the invention, it is contemplated that the ISP become an affiliate of any number of on-line businesses. With reference to FIG. 4, when a user transmits a request to the ISP to retrieve a webpage or other content from an on-line business, the ISP first checks to see if the ISP is an affiliate of the on-line business. If so, then the ISP can append its affiliate information to the request for content by the user. Should the user make any purchases, the ISP is then credited as the affiliate. So as not to override other affiliates, the ISP can first check to see if an affiliate code has already been appended to the request for content by the user (i.e., if the user clicked on a link which already has appended affiliate information to the request for content from the on-line business).

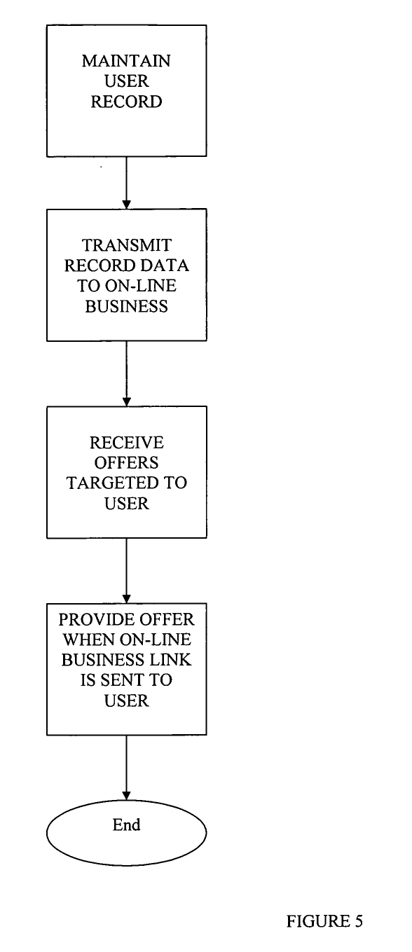

Inasmuch as the ISP is collecting information pertaining to users as to the interests and the webpage habits thereof, such information can be shared with on-line businesses to provide directed advertising to the user. With such information, the on-line business can locate products which are likely of interest to the user. With reference to FIG. 5, once the tracking information is developed and maintained for a user, the ISP can provide the above-described toolbar to the user along with the requested content. The toolbar may have a number of links to the most visited on-line businesses visited by the user. Wherein the link provided relates to an on-line business of which the ISP is an affiliate and with which the ISP shares data pertaining to the user's habits, in addition to the link itself, data pertaining to offers can be transmitted to the user along with the requested content.

For example, a user may be a frequent visitor and purchaser from www.bestbuy.com. The user may likewise be a television enthusiast, spending substantial time visiting television programming and television hardware information sites. As the ISP tracks the website requests and visits by the user, the ISP is aware of these interests of the user. The on-line business, in this example, www.bestbuy.com, is unaware of such interests. Thus, as the ISP shares data with the on-line business, the on-line business can provide data to be appended to the link that the ISP is transmitting to the user related to offers, for example, for television related products or video content for which the user has an apparent heightened interest.

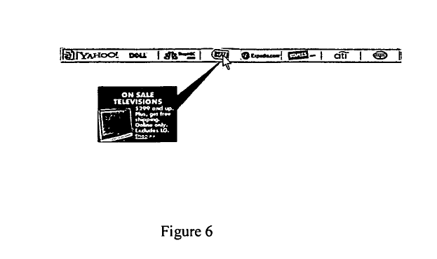

This content can be provided discretely. As is shown in FIG. 6, the offer can remain hidden, and only be accessible by way of a pop-up window that is presented if the user slides the pointer (i.e., mouse or other pointing device) over the link provided by the ISP. With respect to the example above, when the user slides the pointer over the www.bestbuy.com link, an advertisement directed to television hardware appears in a pop-up window. Of course, the system is not limited to discrete content providing nor the use of pop-up windows. The content may be provided in the form of text, pictures, video, etc.

If the user clicks on the link, the ISP will first receive the request for content from the on-line business. The ISP can then append or provide its affiliate data to the request so that the ISP affiliation information can be passed to the on-line business along with the request for content. The on-line business provides content related to the offer presented in the link, or to other offers of which the on-line business believes (based on the information received from the ISP) will be of interest to the user. The hope is that by providing the offers to the user which pertain to the user's apparent areas of interest, the on-line business has a better chance of the user becoming aware of offers from the on-line business, and a much improved chance that the user will be a customer of the on-line business.

The advantage to the ISP is that the ISP facilitates and fosters the information bridge between the user and the on-line business, such that the ISP will receive value added in the form of affiliate revenue.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A processor implemented method for directing content to a user by an internet service provider comprising the steps of:
tracking the websites visited by a user;
identifying at least one on-line business visited by the a user; and
providing a link to the on-line business through a browser.

2. The processor implemented method of claim 1 further comprising the steps of:
providing information pertaining to tracking of a user to an on-line business;
receiving information pertaining to content suited to the user form the on-line business based upon the information provided to the on-line business; and
providing the information to the user from the on-line business within the link provided to the user.

3. The processor implemented method of claim 2 wherein the step of providing information comprises the steps of:
discretely providing the information within the link, such that the information is revealed when a pointer is positioned over the link.

4. The processor implemented method of claim 1 wherein the step of tracking further comprises the steps of:
becoming an affiliate of at least one on-line business;
identifying a request from a user for content from the at least one business;
providing an affiliate identification along with the request for content from the at least one business; and
obtaining the content from the at least one business for the user.

5. The processor implemented method of claim 4 wherein:
the step of identifying further comprises the steps of:
identifying each on-line business visited by the user of which the internet service provider is an affiliate; and
maintaining an ranking of each on-line business based upon visits;
the step of providing further comprises the step of:
providing a link to a predetermined number of on-line businesses based upon the ranking of each on-line business.

6. The processor implemented method of claim 5 wherein:
the predetermined number of on-line businesses comprises at least the four most frequently visited on-line businesses by the user.

7. The processor implemented method of claim 5 further comprising the steps of:
providing information pertaining to tracking of a user to an on-line business;
receiving information pertaining to content suited to the user form the on-line business based upon the information provided to the on-line business; and
providing the information to the user from the on-line business within the link provided to the user.

8. The processor implemented method of claim 7 wherein the step of providing information comprises the steps of:
discretely providing the information within the link, such that the information is revealed when a pointer is positioned over the link.

9. The processor implemented method of claim 1 wherein the link is provided in the form of a tool bar button within a browser window of a user.

10. An apparatus for directing content to a user by an internet service provider comprising:
means for tracking the websites visited by a user;
means for identifying at least one on-line business visited by the a user; and
means for providing a link to the on-line business through a browser.

11. The apparatus of claim 10 further comprising:
means for becoming an affiliate of at least one on-line business;
means for identifying a request from a user for content from the at least one business;
means for providing an affiliate identification along with the request for content from the at least one business; and
means for obtaining the content from the at least one business for the user.

12. The apparatus of claim 11 wherein:
the identifying means further comprises:
means for identifying each on-line business visited by the user of which the internet service provider is an affiliate; and
means for maintaining an ranking of each on-line business based upon visits;
the providing means further comprises:
means for providing a link to a predetermined number of on-line businesses based upon the ranking of each on-line business.

13. The apparatus of claim 12 wherein the predetermined number of on-line businesses comprises at least the four most frequently visited on-line businesses by the user.

14. The apparatus of claim 12 further comprising:
means for providing information pertaining to tracking of a user to an on-line business;
means for receiving information pertaining to content suited to the user form the on-line business based upon the information provided to the on-line business; and
means for providing the information to the user from the on-line business within the link provided to the user.

15. The apparatus of claim 14 wherein the providing means further comprises means for discretely providing the information within the link, such that the information is revealed when a pointer is positioned over the link.

16. An article of manufacture for managing the viewing of images by a user comprising:
A computer-readable medium configured with instructions for causing a processor-based system to perform the steps of:
tracking the websites visited by a user;
identifying at least one on-line business visited by the a user; and
providing a link to the on-line business through a browser.

17. The article of manufacture of claim 16 further comprising:
a computer-readable medium configured with instructions for causing a processor-based system to perform the steps of:
becoming an affiliate of at least one on-line business;
identifying a request from a user for content from the at least one business;
providing an affiliate identification along with the request for content from the at least one business; and
obtaining the content from the at least one business for the user.

18. The article of manufacture of claim 17 further comprising:
a computer-readable medium configured with instructions for causing a processor-based system to perform the steps of:
identifying each on-line business visited by the user of which the internet service provider is an affiliate; and
maintaining an ranking of each on-line business based upon visits; and
providing a link to a predetermined number of on-line businesses based upon the ranking of each on-line business.

19. The article of manufacture of claim 16 further comprising:
a computer-readable medium configured with instructions for causing a processor-based system to perform the steps of:
providing information pertaining to tracking of a user to an on-line business;
receiving information pertaining to content suited to the user form the on-line business based upon the information provided to the on-line business; and
providing the information to the user from the on-line business within the link provided to the user.

20. The article of manufacture of claim 17 further comprising:
a computer-readable medium configured with instructions for causing a processor-based system to perform the step of:
embedding the information within the link, such that the information is revealed when a pointer is positioned over the link.
